(19) United States
(12) Patent Application Publication
(10) Pub. No.: US 2013/0075220 A1
(43) Pub. Date: Mar. 28, 2013

(54) CLUTCH WATER PUMP, CONTROL SYSTEM THEREOF, AND CONTROL METHOD THEREOF

(71) Applicants: Hyundai Motor Company, Seoul (KR); Kia Motors Corporation, Seoul (KR)

(72) Inventors: Seogjin Yoon, Suwon-city (KR); Jong Ho LEE, Hwaseong-city (KR); Yoonghwa PARK, Seoul (KR)

(73) Assignees: Kia Motors Corporation, Seoul (KR); Hyundai Motor Company, Seoul (KR)

(21) Appl. No.: 13/683,564

(22) Filed: Nov. 21, 2012

Related U.S. Application Data
(62) Division of application No. 12/616,643, filed on Nov. 11, 2009.

(30) Foreign Application Priority Data
Aug. 28, 2009 (KR) 10-2009-0080780

(51) Int. Cl. B60W 10/02; F16D 27/02

(52) U.S. Cl. CPC B60W 10/02; F16D 27/02
USPC 192/84.9; 701/68

(57) ABSTRACT

A clutch water pump may include a pulley, a brake pad attached on an interior surface of the clutch compartment of the pulley, a clutch disk disposed corresponding to the brake pad in the clutch compartment, a hub rotatably mounted into the penetrating hole and coupled to the clutch disk through a plurality of spring pins, the plurality of spring pins connecting slidably the clutch disk to the hub, a magnetic actuator fixed to the hub and disposed to the clutch disk to selectively move the clutch disk toward or away from the brake pad, and a main shaft, one end of which is fixed to the center of the hub and the other end of which is fixed to an impeller. Furthermore, a method of controlling the clutch water pump according to the engine rotation speed, the coolant temperature, and a condition of the coolant temperature sensor is provided.

### CROSS-REFERENCE TO RELATED APPLICATION

The present application claims priority to Korean Patent Application No. 10-2009-0080780 filed on 28 Aug. 2009, the entire contents of which are incorporated herein for all purposes by this reference.

### BACKGROUND OF THE INVENTION

1. Field of the Invention

The present invention relates to a water pump that is applied in a vehicle. More particularly, this invention relates to a clutch water pump, and a control system and control method thereof improving fuel efficiency by applying an electric clutch in the water pump.

2. Description of Related Art

Vehicle manufacturers are currently attempting to improve fuel efficiency as well as exhaust gas quality through research processes thereof, and they have specifically increased a catalyst amount of the exhaust system or the capacity of the EGR cooler so as to satisfy emission regulations.

Generally, a coolant is forcibly circulated in a vehicle, coolant paths are formed in a cylinder block and a cylinder head of the vehicle, and a water pump pumps the coolant through the paths so as to sustain the temperature of the engine thereof.

The water pump that pumps the coolant is operated by rotation torque that is transmitted from a belt or a timing belt to circulate the coolant through the predetermined paths of “radiator→cylinder block→cylinder head→radiator”, so as to prevent the engine from being overheated.

An impeller of the water pump is rotated by the rotation torque transferred from the engine through the belt to pump the coolant to the cylinder block, and the rotation speed of the impeller is 1.2-1.6 times that of the crankshaft.

However, as the water pump is always operated, there is a problem that the power of the crankshaft is lost in such a manner that the output of the engine is deteriorated and the fuel efficiency becomes lower.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a clutch water pump, a control system thereof, and a control method thereof having advantages of applying an electric clutch in a water pump, and controlling the electric clutch so as to adjust the operational time of the water pump depending on the driving condition of an engine, the coolant temperature, and the intention of a driver in such a manner that the fuel efficiency and the exhaust gas quality are simultaneously improved.

In an aspect of the present invention, the clutch water pump may include a pulley in which a penetration hole is formed at a center portion thereof and a clutch compartment is formed on a rear side surface thereof, a brake pad that is attached on an interior surface of the clutch compartment of the pulley, a clutch disk that is disposed corresponding to the brake pad in the clutch compartment, a hub that is rotatably mounted into the penetrating hole and is coupled to the clutch disk through a plurality of spring pins, the plurality of spring pins connecting slidably the clutch disk to the hub, a magnetic actuator fixed to the hub and disposed to the clutch disk to selectively move the clutch disk toward or away from the brake pad, and a main shaft, one end of which is fixed to the center of the hub and the other end of which is fixed to an impeller.

Plurality of spring pins may be formed on the external circumference of the hub to elastically support the clutch disk toward the brake pad.

The magnetic actuator may include a field coil that is disposed corresponding to the clutch disk and covered by a coil case and a cover, wherein the filed coil is magnetized by an external control signal to generate magnetic force to the clutch disk so as to connect or disconnect the clutch disk to or from the brake pad, wherein the clutch disk is connected to the brake pad to supply rotation torque of the pulley to the impeller so as to pump a coolant in a case that the field coil is not magnetized, and wherein the clutch disk is disconnected from the brake pad in a case that the field coil is magnetized.

In another aspect of the present invention, the control method of controlling the clutch water pump may include operating the clutch water pump if engine rotation speed exceeds a predetermined standard value, if coolant temperature exceeds a first predetermined value, if a heater switch is on, or if a coolant temperature sensor is out of order, operating the clutch water pump in a first operating condition if the engine rotation speed is lower than the predetermined standard value and the coolant temperature ranges from the first predetermined value to a second predetermined value, wherein the first predetermined value is higher than the second predetermined value, operating the clutch water pump in a second operating condition if the engine rotation speed is lower than the predetermined standard value and the coolant temperature ranges from the second predetermined value to a third predetermined value, wherein the second predetermined value is higher than the third predetermined value, and operating the water pump in a third operating condition if the engine rotation speed is lower than the predetermined standard value and the coolant temperature is lower than the third predetermined value, wherein the coolant temperature sensor is configured to detect the coolant temperature supplied to the clutch water pump.

In further another aspect of the present invention, a control device of a clutch water pump may include an engine rotation speed detecting portion that detects engine rotation speed, a water temperature detecting portion that detects temperature of a coolant, a switch that detects an on/off condition of a heater switch, a control portion that operates the clutch water pump depending on the coolant temperature and the on/off condition of the heater switch, and a clutch that generates magnetic force to control the operation of the clutch water pump depending on control signal of the control portion.

The water temperature detecting portion may be disposed at an outlet of the coolant in a cylinder block.

If the engine rotation speed exceeds a predetermined standard value, if the coolant temperature exceeds a first predetermined value, if the heater switch is on, or if the coolant temperature sensor is out of order, the control portion may operate the clutch water pump.

If the engine rotation speed is lower than a predetermined standard value and the coolant temperature ranges from a first predetermined value to a second predetermined value, the control portion may operate the clutch water pump in a first operating condition, the first predetermined value being higher than the second predetermined value.

If the engine rotation speed is lower than a predetermined standard value and the coolant temperature ranges from a second predetermined value to a third predetermined value, the control portion may operate the clutch water pump in a second operating condition, the second predetermined value being higher than the third predetermined value.

If the engine rotation speed is lower than a predetermined standard value and the coolant temperature is lower than a third predetermined value, the control portion may operate the clutch water pump in a third operating condition.

In another aspect of the present invention, a control method of controlling a clutch water pump, may include detecting an engine driving condition, a coolant temperature, an operating condition of a heater switch, and a will of a driver, and analyzing the detected information, and operating the clutch water pump by controlling an electric clutch depending on an engine rotation speed, the coolant temperature, and the operating condition of the heater switch, wherein if the engine rotation speed exceeds a predetermined standard value, the electric clutch is turned off to operate the clutch water pump, wherein the electric clutch is turned off to operate the clutch water pump so as to raise the temperature of the interior while the heater switch is turned on, wherein if a fault of a coolant temperature sensor that detects the coolant temperature is recognized, the electric clutch is turned off to operate the clutch water pump in a limp-home mode, wherein if the engine rotation speed is lower than a predetermined standard value and the coolant temperature ranges from a first predetermined value to a second predetermined value that is lower than the first predetermined value, the electric clutch is operated in a first condition to operate the clutch water pump, wherein if the engine rotation speed is lower than a predetermined standard value and the coolant temperature ranges from a second predetermined value to a third predetermined value that is lower than the second predetermined value, the electric clutch is operated in a second condition to operate the clutch water pump, and wherein if the engine rotation speed is lower than a predetermined standard value and the coolant temperature is lower than a third predetermined value, the electric clutch is operated in a third condition to operate the clutch water pump.

In various aspects of the present invention having the above configuration, the temperature of the exhaust gas is quickly increased after starting the engine in such a manner that the purification rate of the exhaust gas is correspondingly increased, and therefore it is not necessary to add an additional catalyst in the purification device such that the cost and the weight is reduced.

Also, when the engine is started in cold weather, the engine temperature is increased to a normal value in such a manner that the fuel consumption is improved.

In addition, the coolant is actively controlled after starting the engine to shorten the warm-up time in such a manner that the fuel consumption is reduced, and the activation time of the catalyst is reduced.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing an external shape of a clutch water pump according to an exemplary embodiment of the present invention.

FIG. 2 is an exploded perspective view of a clutch water pump according to an exemplary embodiment of the present invention.

FIG. 3 is a cross-sectional view showing a non-operational condition of a clutch of a clutch water pump according to an exemplary embodiment of the present invention.

FIG. 4 is a cross-sectional view showing an operational condition of a clutch of a clutch water pump according to an exemplary embodiment of the present invention.

FIG. 5 shows a control apparatus of a clutch water pump according to an exemplary embodiment of the present invention.

FIG. 6 is a flowchart showing control procedures for a clutch water pump according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown.

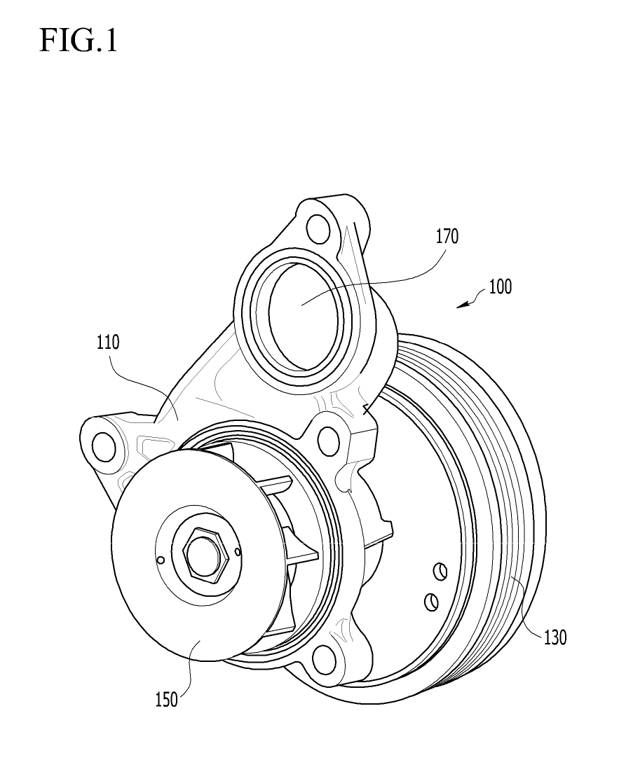

FIG. 1 is a perspective view showing an external shape of a clutch water pump according to an exemplary embodiment of the present invention.

A clutch water pump 100 includes a body 110, a pulley 130 that is mounted on one side of the body 110 to receive rotation torque from a crankshaft of an engine, and an impeller 150 that is mounted on a main shaft that is disposed in the center portion of the pulley to pump coolant, wherein a coolant inlet 170 is formed on the body 110.

Accordingly, the pulley 130 is rotated by the rotation torque that is transmitted from the crankshaft through a belt, and the impeller 150 that is mounted on the main shaft is rotated by the pulley 130.

Therefore, the coolant that is supplied to the coolant inlet 170 is pumped by the impeller 150 to circulate it through the engine so as to sustain the temperature of the engine in a stable condition.

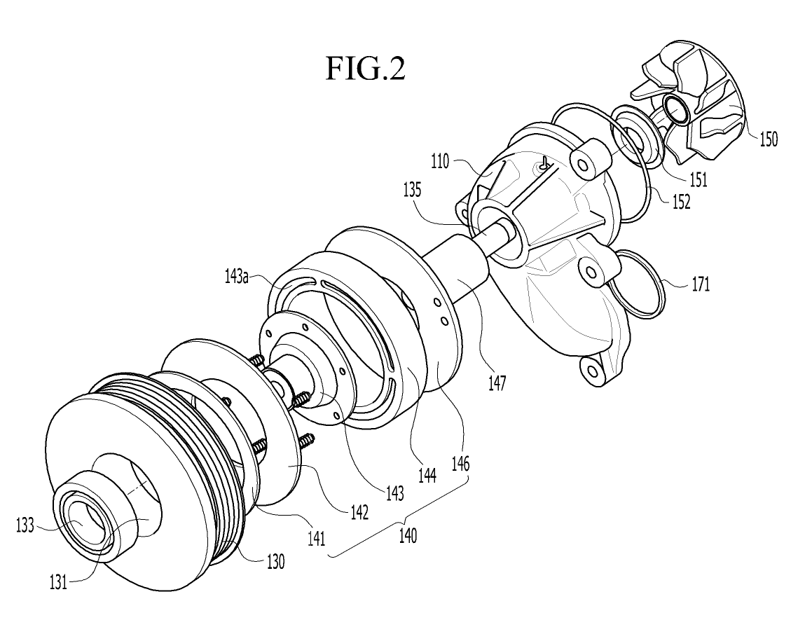

FIG. 2 is an exploded perspective view of a clutch water pump according to an exemplary embodiment of the present invention.

The clutch pump according to the exemplary embodiment of the present invention includes a body 110, a pulley 130, an electric clutch 140, and an impeller 150.

The pulley 130 is mounted on the main shaft to receive the power from the crankshaft of an engine through the belt, a penetration hole 131 is formed in the center portion thereof, and a pulley bearing 133 is inserted therein.

A clutch compartment is formed at the rear surface of the pulley 130 along the circumference of the penetration hole that is formed at the center portion of the pulley 130, a brake pad 141 is attached to the interior surface of the clutch compartment, and a clutch disk 142 is disposed to face the brake pad 141.

Rotation torque of the pulley is transmitted to the impeller depending on the contact condition of the brake pad 141 and the clutch disk 142.

One side of a hub 143 is engaged with a pulley 130 through a pulley bearing 133 that is inserted into the penetration hole 131 of the pulley 130, and a plurality of spring pins 143a that are disposed along the external circumference of the hub 143 elastically push the clutch disk 142 to the brake pad.

A field coil 145 is disposed at the rear side of the clutch disk 142, the field coil 145 is covered by a coil case 144 and a cover 146, and the field coil 145 draws the clutch disk 142 by a magnetic force in such a manner that the clutch disk 142 is detached from the brake pad.

Also, a main shaft 135 is rotatably disposed in the body 110 through a pump bearing 147, one end of the main shaft 135 is connected to the center portion of the hub 143, and the other end thereof is connected to the impeller 150, and a seal 151 is interposed between the impeller and the main shaft 135.

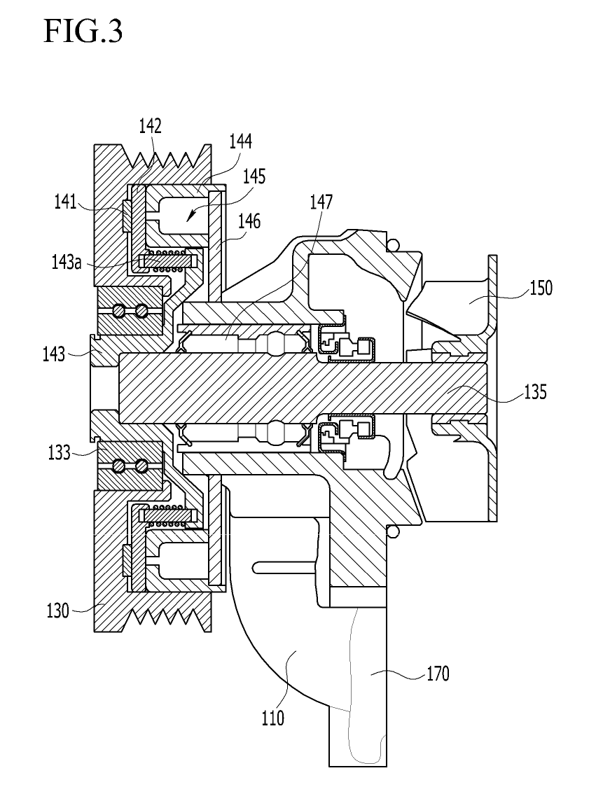

As shown in FIG. 3, in a condition in which the filed coil 145 is not magnetized, the clutch disk 142 and the brake pad 141 are engaged with each other by the elastic force of the spring pins 143a that are disposed along the external circumference of the hub 143.

Accordingly, the rotation torque of the pulley 130 is transmitted to the clutch disk 142, the spring pins 143a, the hub 143, and the main shaft 135 to rotate the impeller 150 in such a manner that the coolant is pumped.

However, the field coil 145 is magnetized to generate magnetic force by an external control signal, and the magnetic force draws the clutch disk 142 overcoming the elastic force of the plurality of spring pins 143a.

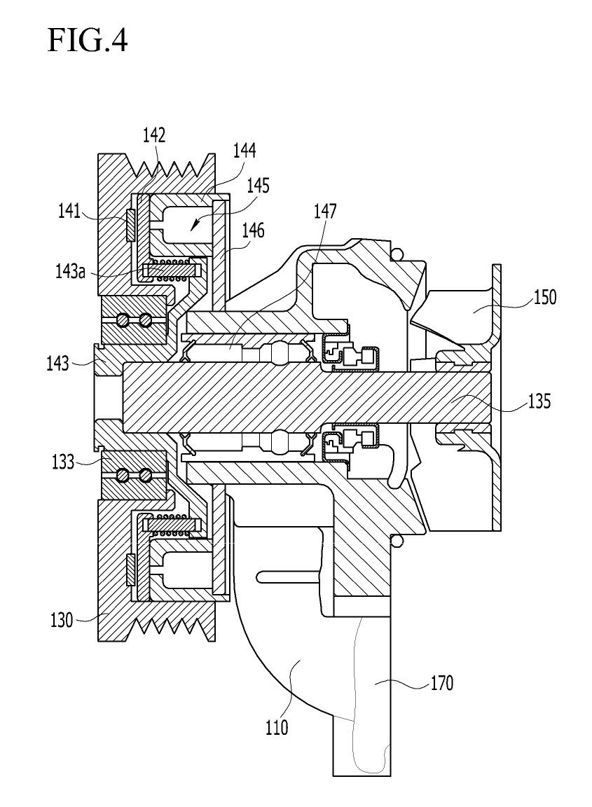

Accordingly, as shown in FIG. 4, the clutch disk 142 is detached from the brake pad 141 that is fixed on the interior surface of the clutch compartment in such a manner that the pulley 130 does not rotate the impeller 150.

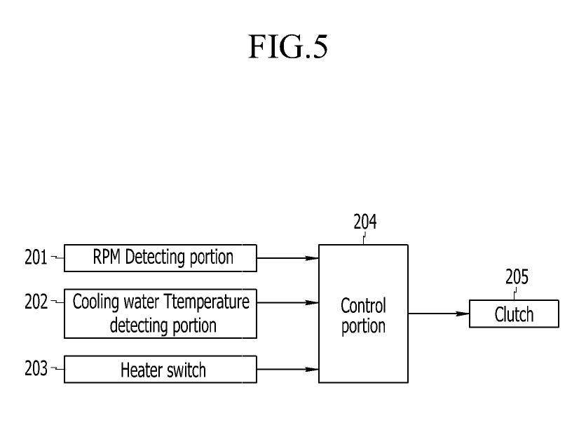

FIG. 5 shows a control apparatus of a clutch water pump according to an exemplary embodiment of the present invention.

The control apparatus according to the present invention includes an engine speed detecting portion 201, a water temperature detecting portion 202, a heater switch 203, a control portion 204, and a clutch 205.

The engine speed detecting portion 201 detects the engine rotation speed (RPM) from the crankshaft or a camshaft to offer the related information to the control portion 204.

The water temperature detecting portion 202 includes a coolant temperature sensor detecting the coolant temperature, the coolant circulates the circulation path of “radiator→cylinder block→cylinder head→radiator”, and the coolant temperature sensor is disposed at the outlet of the cylinder head to detect the temperature of the coolant discharged out of the cylinder block to transmit the temperature information to the control portion 204.

The heater switch 203 is one element of the air conditioner to offer an operational condition thereof to the control portion 204.

The control portion 204 controls the water pump by stages depending on the engine speed, the coolant temperature, and the operational condition of the heater.

The control portion 204 always operates the water pump to circulate the coolant in a case in which the engine speed is in a high range to exceed a predetermined standard value, for example, 3000 RPM.

Also, the control portion 204 always operates the water pump to circulate the coolant if the engine speed is lower than a determined standard value and the coolant temperature is higher than a first predetermined value, for example, 85° C.

Also, the control portion 204 always operates the water pump to circulate the coolant regardless of the coolant temperature and the engine speed so as to quickly heat the air, if the heater switch is in an operational condition.

Also, if the coolant temperature sensor is disabled, the control portion 204 performs a limp-home mode to operate the water pump in such a manner that the coolant is always circulated.

The control portion 204 periodically operates the water pump in a first condition, if the engine speed is lower than a predetermined standard value and the coolant temperature ranges from a first predetermined value and a second predetermined value.

For example, the first predetermined value is 85° C., and the second predetermined value is 65° C.

Also, the water pump stops operating for 100 seconds and then operates for 2 seconds in the first condition.

Further, if the engine speed is lower than a predetermined standard value and the coolant temperature ranges from a second predetermined value to a third predetermined value, the control portion 204 periodically operates the water pump in a second condition.

For example, the second predetermined value is 65° C. and the third predetermined value is 40° C.

In addition, the water pump stops operating for 150 seconds and then operates for 1 second in the second condition.

If the engine speed is lower than a predetermined standard value and the coolant temperature is lower than a third predetermined value, the control portion 204 periodically operates the water pump in a third condition.

And, the water pump stops operating for 200 seconds, and then operates for 1 second in the third condition.

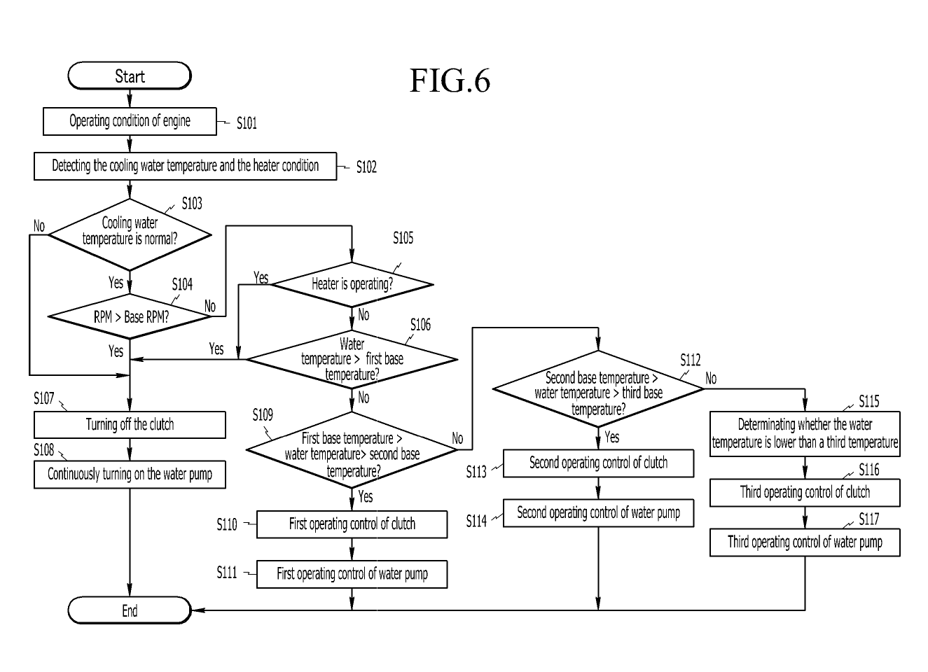

Referring to FIG. 6, the water pump operation through the control of the clutch will hereinafter be explained.

The engine is operated in step S101, and the control portion 204 receives signals of sensors that are mounted on a vehicle to detect the engine speed (RPM), the coolant temperature, and the operational condition of the heater switch in step S102.

After that, the control portion analyses the detected information and determines whether the coolant temperature sensor is normally operated in step S103, and if it is determined that the coolant temperature sensor is disabled, the control portion performs limp-home mode. The method for determining the fault of the coolant temperature sensor is known publicly, so a detailed description will be omitted.

As shown in FIG. 3, the clutch 205 is turned off in step S107 to always operate the impeller 150 in such a manner that the impeller 150 circulates the coolant in step S108.

That is, the control portion 204 performs the limp-home mode when the coolant temperature sensor is disabled, and the water pump is always operated to circulate the coolant in such a manner that the engine is not overheated.

Also, if the coolant temperature sensor is normally operated in step S103, it is determined whether the engine speed (RPM) exceeds a predetermined standard value, for example, 3000 RPM in step S104.

If the engine speed exceeds a predetermined standard value, the control portion determines that the engine is in too high a speed condition in step S104 to stop water pump operation, and as shown in a FIG. 3, the control portion turns off the clutch to always operate the water pump in step S107 and S108.

If the engine speed is lower than the predetermined standard value in step S104, the control portion determines whether the heater switch is turned on in step S105.

If it is determined that the heater switch is in an operational condition in step S105, the clutch 205 is turned off to operate the water pump in step S107 and step S108 as shown in FIG. 3 in such a manner that the air is quickly heated.

However, if it is determined that the heater switch is turned off in step S105, it is determined whether the coolant temperature exceeds a first predetermined value, for example, 85° C. in step S106.

If it is determined that the coolant temperature exceeds a first predetermined value in step S106, the control portion determines whether the vehicle is sufficiently warmed up, and as shown in FIG. 3, the clutch 205 is controlled to be turned off in such a manner that the water pump is always operated in step S107 and step S108.

However, if the coolant temperature is lower than a first predetermined value in step S106, it is determined whether the coolant temperature ranges from a first predetermined value to a second predetermined value in step S109.

For example, it is determined whether the coolant temperature ranges from 85° C. to >65° C.

If the coolant temperature ranges from a first predetermined value to a second predetermined value in step S109, the clutch 205 is controlled to operate the water pump in a first condition in step S111.

For example, referring to FIG. 3 and FIG. 4, the water pump is not operated for 100 seconds, and then the water pump is operated for 2 seconds in such a manner that the engine is adequately cooled.

If the coolant temperature is not between a first predetermined value and a second predetermined value in step S109, it is determined whether the coolant temperature is between a second predetermined value and a third predetermined value in step S112.

For example, it is determined whether the coolant temperature ranges from 65° C. to 40° C.

If the coolant temperature is included between a second predetermined value and a third predetermined value in step S112, the clutch 205 is controlled to operate the water pump in a second condition in step S114.

For example, referring to FIG. 3 and FIG. 4, the water pump is not operated for 150 seconds, and then the water pump is operated for 1 second in such a manner that the coolant is not overheated.

If the coolant temperature is not included between a second predetermined value and a third predetermined value in step S112, it is determined whether the coolant temperature is less than a third predetermined value in step S115, and if the coolant temperature is less than a third predetermined value, the clutch 205 is controlled to operate the water pump in a third condition in step S117.

For example, referring to FIG. 3 and FIG. 4, the control portion operates the water pump for 1 second, and then stops operating the water pump for 200 seconds.

That is, if it is determined that the engine is in the cool condition, the control portion intermittently operates the water pump so as to warm up the engine in such a manner that the pilot injection amount is reduced to a normal condition.

Also, as the engine is quickly warmed up, the exhaust gas temperature is quickly raised to a predetermined temperature in such a manner that the purification efficiency of the exhaust gas is securely raised.

In the FIGS. 2, 152 and 172 are sealing member to perform a watertight function between components.

For convenience in explanation and accurate definition in the appended claims, the terms “up” or “upper”, “down” “downwards”, “lower”, “front”, “rear”, “back”, “inside”, “outside”, “outwardly”, “interior”, “exterior”, “outer”, “inner”, “upwards”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1.-6. (canceled)

7. A control method of controlling the clutch water pump defined in claim 1, comprising:
operating the clutch water pump if engine rotation speed exceeds a predetermined standard value, if coolant temperature exceeds a first predetermined value, if a heater switch is on, or if a coolant temperature sensor is out of order,
operating the clutch water pump in a first operating condition if the engine rotation speed is lower than the predetermined standard value and the coolant temperature ranges from the first predetermined value to a second predetermined value, wherein the first predetermined value is higher than the second predetermined value,
operating the clutch water pump in a second operating condition if the engine rotation speed is lower than the predetermined standard value and the coolant temperature ranges from the second predetermined value to a third predetermined value, wherein the second predetermined value is higher than the third predetermined value, and
operating the water pump in a third operating condition if the engine rotation speed is lower than the predetermined standard value and the coolant temperature is lower than the third predetermined value,
wherein the coolant temperature sensor is configured to detect the coolant temperature supplied to the clutch water pump.

8.-13. (canceled)

14. A control method of controlling a clutch water pump, comprising:
detecting an engine driving condition, a coolant temperature, an operating condition of a heater switch, and a will of a driver; and
analyzing the detected information, and operating the clutch water pump by controlling an electric clutch depending on an engine rotation speed, the coolant temperature, and the operating condition of the heater switch.

15. The control method of claim 14, wherein if the engine rotation speed exceeds a predetermined standard value, the electric clutch is turned off to operate the clutch water pump.

16. The control method of claim 14, wherein the electric clutch is turned off to operate the clutch water pump so as to raise the temperature of the interior while the heater switch is turned on.

17. The control method of claim 14, wherein if a fault of a coolant temperature sensor that detects the coolant temperature is recognized, the electric clutch is turned off to operate the clutch water pump in a limp-home mode.

18. The control method of claim 14, wherein if the engine rotation speed is lower than a predetermined standard value and the coolant temperature ranges from a first predetermined value to a second predetermined value that is lower than the first predetermined value, the electric clutch is operated in a first condition to operate the clutch water pump.

19. The control method of claim 14, wherein if the engine rotation speed is lower than a predetermined standard value and the coolant temperature ranges from a second predetermined value to a third predetermined value that is lower than the second predetermined value, the electric clutch is operated in a second condition to operate the clutch water pump.

20. The control method of claim 14, wherein if the engine rotation speed is lower than a predetermined standard value and the coolant temperature is lower than a third predetermined value, the electric clutch is operated in a third condition to operate the clutch water pump.
